(19) United States
(12) Patent Application Publication
(10) Pub. No.: US 2026/0361252 A1
(43) Pub. Date: Nov. 12, 2026

(54) ELECTRIC MACHINE WITH ADJUSTABLE MULTI-PHASE STATOR WINDINGS

(71) Applicant: DANA TM4 INC., Boucherville (CA)

(72) Inventors: Sandeep VENKATA, Ville-Marie Montreal (CA); Benoit BLANCHARD ST-JACQUES, Boucherville (CA)

(21) Appl. No.: 19/205,785

(22) Filed: May 12, 2025

(51) Int. Cl. H02P 25/22; H02K 3/28

(52) U.S. Cl. CPC H02P 25/22; H02K 3/28

(57) ABSTRACT

Methods and systems are provided for an electric machine. The electric machine system includes, in one example, a stator with a first three-phase winding assembly electrically coupled in parallel to a second three-phase winding assembly electrically coupled in parallel to the first three-phase assembly. The system further includes a first inverter electrically coupled to the first three-phase winding assembly, a second inverter electrically coupled to the second three-phase winding assembly, and multiple electronic and/or mechanical switches that are configured to selectively electrically couple the first and second three-phase winding assemblies.

### TECHNICAL FIELD

The present description relates generally to methods and systems for an electric machine with stator winding configuration adjustment functionality.

### BACKGROUND AND SUMMARY

Electric machines are designed with different stator winding configurations that each constrain certain aspects of motor performance. For instance, three-phase motors have been used in certain applications due to their reduced complexity when compared to higher phase motors. Six-phase motors have been used in other applications to achieve increased torque and smoother operation in relation to lower phase motors.

Attempts have been made to design motors with both three and six phase operational capabilities. U.S. Pat. No. 9,680,344 B2 to Atalla et al. discloses a motor with auxiliary windings that are separate from main windings that allow the motor to be switched into a three-phase mode from a six-phase mode. In Atalla's motor, the auxiliary windings are de-energized while the motor is operated as a generator and both the main and auxiliary windings are energized in a motoring mode.

The inventors have recognized several issues with Atalla's system and other previous motors. For instance, the use of auxiliary windings in Atalla's motor increases the motor's complexity and size. The inventors have also recognized that hairpin stator windings can constrain winding selection flexibility. Therefore, hairpin windings may pose challenges in designing a motor with multiple winding configurations. Further, the type of inverter used in the motor system can constrain the type winding configuration used in the motor in certain systems.

The inventors have recognized the abovementioned issues with previous motors and switching devices and developed an electric machine system to at least partially address the challenges. The electric machine system includes a stator with a first three-phase winding assembly electrically coupled in parallel to a second three-phase winding assembly electrically coupled in parallel to the first three-phase assembly. The electric machine system further includes a first three-phase inverter electrically coupled to the first three-phase winding assembly, a second three-phase inverter electrically coupled to the second three-phase winding assembly, and multiple electronic and/or mechanical switches that are configured to selectively electrically couple the first and second three-phase winding assemblies. The electric machine system may further include a controller that is configured to operate the electric machine system in a three-phase motoring mode, during a first condition and operate the electric machine system in a six-phase motoring mode, during a second condition. In this way, the electric machine is able to switch the stator's winding configuration during motoring to increase motor adaptability, as well as motor and inverter performance and efficiency.

Further, in one example, the first and second three-phase windings are mechanically distributed at 180° degrees to reduce mutual coupling between them. This arrangement reduces (e.g., minimizes) the interaction of ripple current between the two three-phase circuits.

In one example, operating the electric machine system in the six-phase mode may include operating the first and second inverters to transfer power to the first three-phase winding assembly and the second first three-phase winding assembly, respectively. Alternatively, one inverter can be switched off to operate in three-phase mode. In this way, the machine's performance is increased.

Additionally, in one example, the multiple electronic devices may include three contactors. This configuration allows the machine to handle higher torque with the same current using specific switch logic. Furthermore, different electric switch logic can enable the six-phase configuration.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a first example of a circuit diagram of electric machine with a winding reconfiguration assembly.

FIGS. 2A-2C show different views of a stator with a reconfigurable winding assembly.

FIG. 3 shows a circuit diagram for internal winding connections in the stator depicted in FIGS. 2A-2C.

FIG. 4 shows a diagram of a multi-phase winding scheme in the stator depicted in FIGS. 2A-2C.

FIG. 5 shows a second example of a circuit diagram of electric machine with a winding reconfiguration assembly.

FIG. 6 shows a third example of a circuit diagram of electric machine with a winding reconfiguration assembly.

FIG. 7 shows an operational diagram that corresponds to the electric machine depicted in FIG. 1.

FIG. 8 shows an operational diagram that corresponds to the electric machine depicted in FIG. 5.

FIG. 9 shows an operational diagram that corresponds to the electric machine depicted in FIG. 6.

### DETAILED DESCRIPTION

An electric machine with main stator windings that have phase switching capabilities is described herein. Specifically, the electric machine is configured to switch between a three-phase mode and a six-phase mode using switches (e.g., contactors) that selectively couple parallel three-phase circuits. In the system, multiple inverters are electrically connected to the electric machine to enable the parallel three-phase circuits to be selectively powered in the machine's different modes of operation.

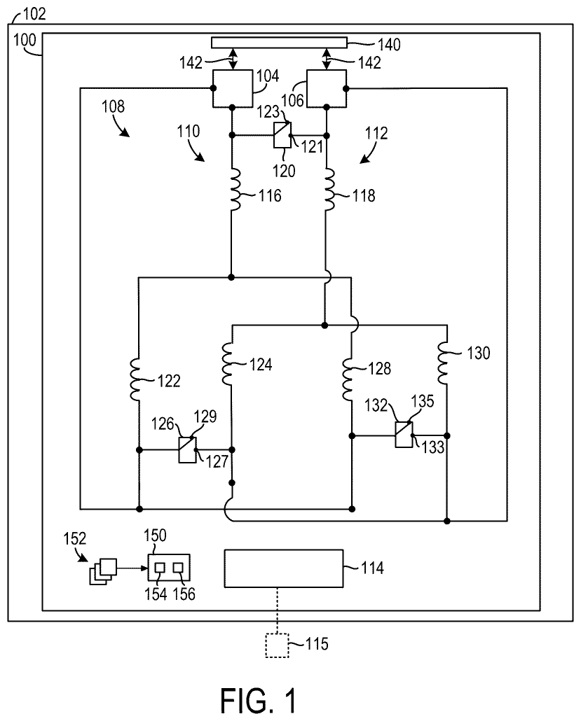

FIG. 1 shows an electric circuit diagram of an electric machine system 100 with winding reconfiguration functionality. In the diagram, circles represent electrical junctions.

The electric machine system 100 may be included in an electric drive unit 102 of an electric vehicle (e.g., a battery electric vehicle or a hybrid electric vehicle) such as an electric axle, in one specific example. As such, the electric machine depicted in FIG. 1 may be a traction motor (e.g., traction motor-generator), in one example. However, the electric machine system 100 may be used in other systems such in industrial systems, machine tools, appliances, and the like. The electric machine shown in FIG. 1 as well as the other machines described herein may be operated in a motoring mode where rotational output is delivered to downstream components and in a generator mode where the machine receives rotational input from the downstream components and generates electrical energy.

The electric machine system 100 includes inverters 104 and 106 as well as a stator 108. The stator 108 includes multiple three-phase circuits. To elaborate, the stator 108 includes one three-phase winding assembly 110 and another three-phase winding assembly 112. Each of these three-phase winding assemblies 110 and 112 are connected in parallel. To elaborate, the three-phase winding assemblies 110 and 112 may be configured such that there is 0° of phase shift when switching between a three-phase motoring mode and a six-phase motoring mode as elaborated upon herein. Further, the windings in each of the three-phase winding assemblies 110 and 112 may specifically be hairpin windings. Using hairpin windings in the electric machine allows the machine's performance (e.g., torque) to be increased in comparison to round windings.

The stator 108 electromagnetically interacts with a rotor 107, which is schematically depicted in FIG. 1. In turn, the rotor 107 may include a rotor shaft coupled to a downstream component 115 such as an input shaft for a gearbox or a transmission, when the electric machine is deployed in a vehicle. However, it will be understood that the electric machine and corresponding winding reconfiguration assembly may be used in other systems.

The three-phase winding assembly 110 includes a phase winding 116 (e.g., a red phase winding). The three-phase winding assembly 112 similarly includes a phase winding 118 (e.g., a red phase winding). An electronic or mechanical switch 120 is configured to selectively electrically couple the phase winding 116 in the three-phase winding assembly 110 and the phase winding 118 in the three-phase winding assembly 112. The switch 120 is specifically a two-position electronic switch, in the illustrated example. However, other switch configurations are possible. In a closed position (indicated at 121), the switch 120 electrically couples inputs of the phase windings 116 and 118. Conversely, in an open position (indicated at 123) of the switch 120, the phase windings 116 and 118 are electrically decoupled from one another. The switch 120 and the other switches depicted in FIG. 1 may be a contactor or mechanical switch, in different examples. The other electronic devices described herein with regard to FIG. 1 may similarly be electrical switches such as contactors. Using contactors in the stator circuit allows the electric machine to handle higher currents than other types of switches and increases the machine's electrical efficiency.

The three-phase winding assembly 110 includes a phase winding 122 (e.g., a yellow phase winding). The three-phase winding assembly 112 similarly includes a phase winding 124 (e.g., a yellow phase winding). An electronic or mechanical switch 126 is configured to selectively electrically couple an input of the phase winding 122 in the three-phase winding assembly 110 and an input of the phase winding 124 in the three-phase winding assembly 112. The switch 126 is specifically a two-position electronic switch, in the illustrated example. However, other switch configurations are possible. In a closed position (as indicated at 127), the switch 126 electrically couples the phase windings 122 and 124. Conversely, in an open position (as indicated at 129) of the switch 126, the phase windings 122 and 124 are electrically decoupled from one another.

The three-phase winding assembly 110 includes a phase winding 128 (e.g., a blue phase winding). The three-phase winding assembly 112 similarly includes a phase winding 130 (e.g., a blue phase winding). An electronic or mechanical switch 132 is configured to selectively electrically couple the phase winding 128 in the three-phase winding assembly 110 and the phase winding 130 in the three-phase winding assembly 112. The switch 132 is specifically a two-position electronic switch, in the illustrated example. However, other switch configurations are possible. In a closed position (as indicated at 133), the switch 132 electrically couples inputs of the phase windings 128 and 130. Conversely, in an open position (as indicated at 135) of the switch 132, the phase windings 128 and 130 are electrically decoupled from one another.

In the three-phase winding assembly 110, the phase winding 116 is electrically coupled to the phase winding 122 and the phase winding 128. Further, in the three-phase winding assembly 110 the phase winding 116 is electrically coupled to the inverter 104. Additionally, in the three-phase winding assembly 110, the phase winding 122 and the phase winding 128 are each electrically coupled to the inverter 104.

In the three-phase winding assembly 112, the phase winding 118 is electrically coupled to the phase winding 124 and the phase winding 130. Further, in the three-phase winding assembly 112 the phase winding 118 is electrically coupled to the inverter 106. Additionally, in the three-phase winding assembly 112 the phase winding 124 and the phase winding 130 are each electrically coupled to the inverter 106.

Further, the stator 108 of the electric machine electromagnetically interact with a rotor 107, which is schematically depicted in FIG. 1. In turn, the rotor 107 may include a rotor shaft coupled to a drivetrain component such as an input shaft for a gearbox or a transmission, when the electric machine is deployed in a vehicle. However, it will be understood that the electric machine and corresponding winding reconfiguration assembly may be used in other systems.

The inverters 104 and 106 are electrically coupled to one or more energy storage device(s) 140 as indicated via arrows 142. During a motoring mode, electric power flows from the energy storage device(s) 140 (e.g., batteries, capacitors, combinations thereof, and the like) to the electric machine. Conversely, during a generator mode, electric power flows from the electric machine to the energy storage device(s) 140.

A controller 150 (e.g., a machine control unit (MCU)) may augment the electrical power delivered from the inverters 104 and 106 to the stator 108. The controller 150 receives inputs from sensors 152. The sensors may include switch position sensors that are coupled to the switches 120, 126, and 132, a state of charge sensor for the energy storage device(s), etc.

In other examples, the sensor may be omitted from the assembly. The sensors 152 may send signals to the controller 150 which are indicative of the positions of the switches in the system.

The controller 150 includes a processor 154 and memory 156. The memory 156 holds instructions stored therein that when executed by the processor 154 cause the controller 150 to perform the various methods, control techniques, and the like, described herein. The processor 154 may include a microprocessor unit and/or other types of circuits. The memory 156 includes known data storage mediums such as random access memory, read only memory, keep alive memory, combinations thereof, and the like. Sensors 152 are in electronic communication with the controller 150 and provide signals thereto. These sensors may include an electric machine speed sensor, an electric machine temperature sensor, the auxiliary contact sensor, an accelerator pedal position sensor, a battery state of charge sensor, an inverter current sensor, and the like. The controller 150 is configured to send control commands to the switches in the system as well as the inverter to adjust operation thereof. For instance, the controller may include instructions stored in memory for implementing the control techniques described in greater detail herein.

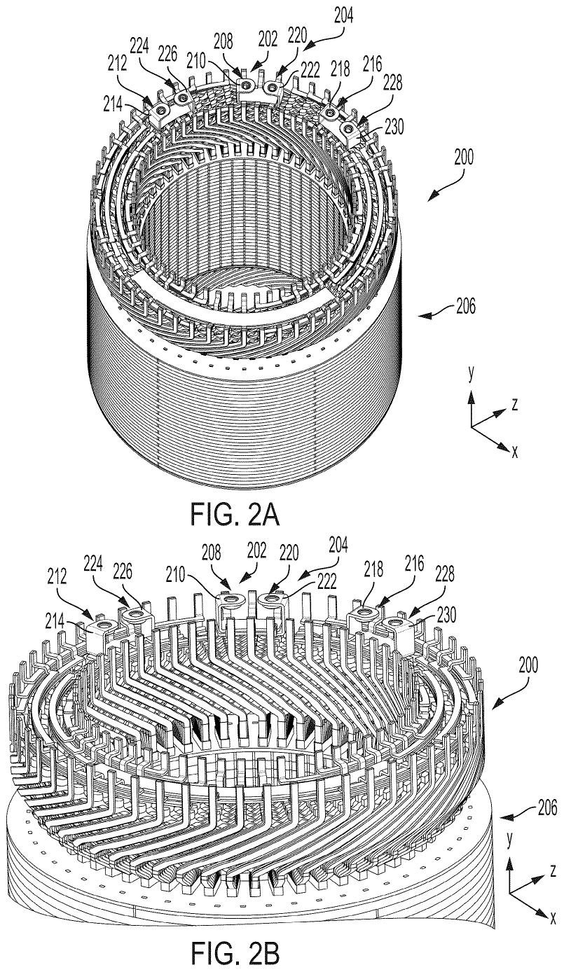

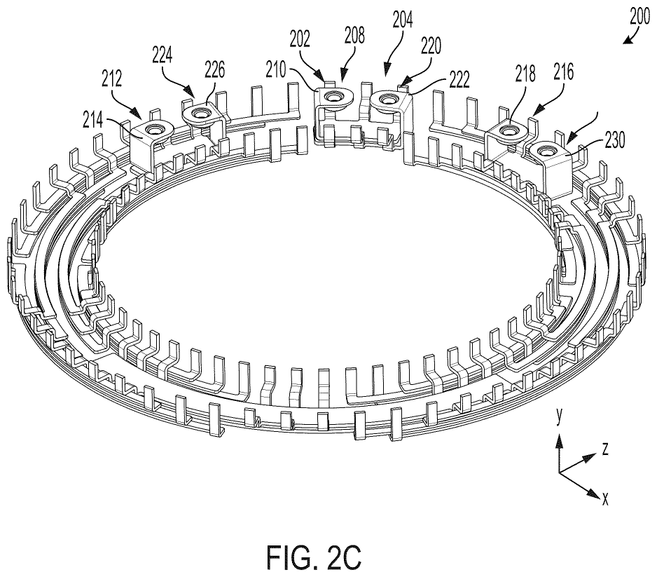

FIGS. 2A-2C show different views of an example of a stator 200 with one three-phase winding assembly 202 and another three-phase winding assembly 204 that both extend through a stack of stator laminations 206. To elaborate, the winding assemblies 202 and 204 are main winding assemblies.

The three-phase winding assembly 202 includes a phase winding 208 with an electrical interface 210 (e.g., electrical terminal), a phase winding 212 with an electrical interface 214, and a phase winding 216 with an electrical interface 218.

The three-phase winding assembly 204 includes a phase winding 220 with an electrical interface 222 (e.g., electrical terminal), a phase winding 224 with an electrical interface 226, and a phase winding 228 with an electrical interface 230.

An axis system is provided in FIGS. 2A-2C for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

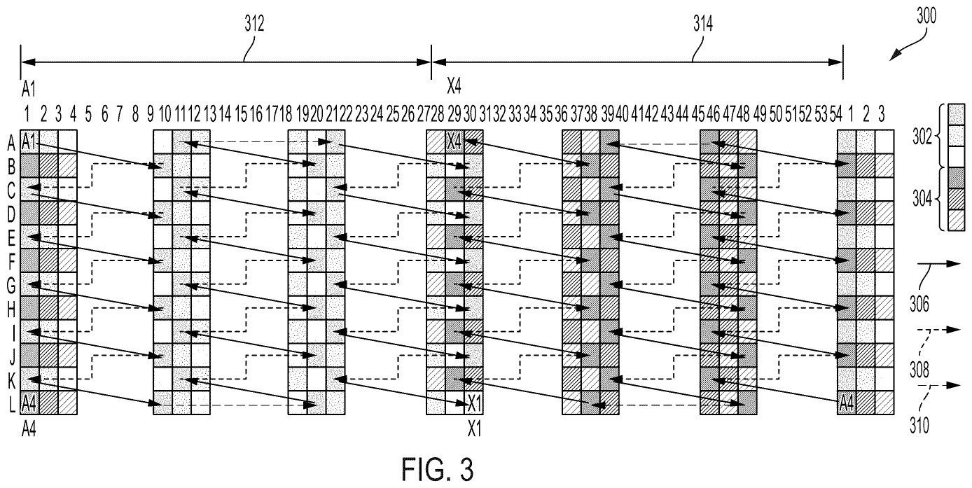

FIG. 3 shows a circuit diagram 300 that corresponds to internal circuitry in a stator such as the stator 108 shown in FIG. 1 and/or the stator 200 shown in FIGS. 2A-2C.

The phase windings in a first three-phase winding assembly is indicated at 302. Conversely, the phase windings in another three-phase winding assembly is indicated at 304. Hairpin connections 306, back end connections 308, and jumper connections 310 are further depicted in FIG. 3. 0°-180° of the stator's mechanical circumference is indicated at 312. Similarly, 180°-360° of the stator's mechanical circumference is indicated at 314. Rows A-L indicate the layers of the windings from an inner diameter at A to an outer diameter at L.

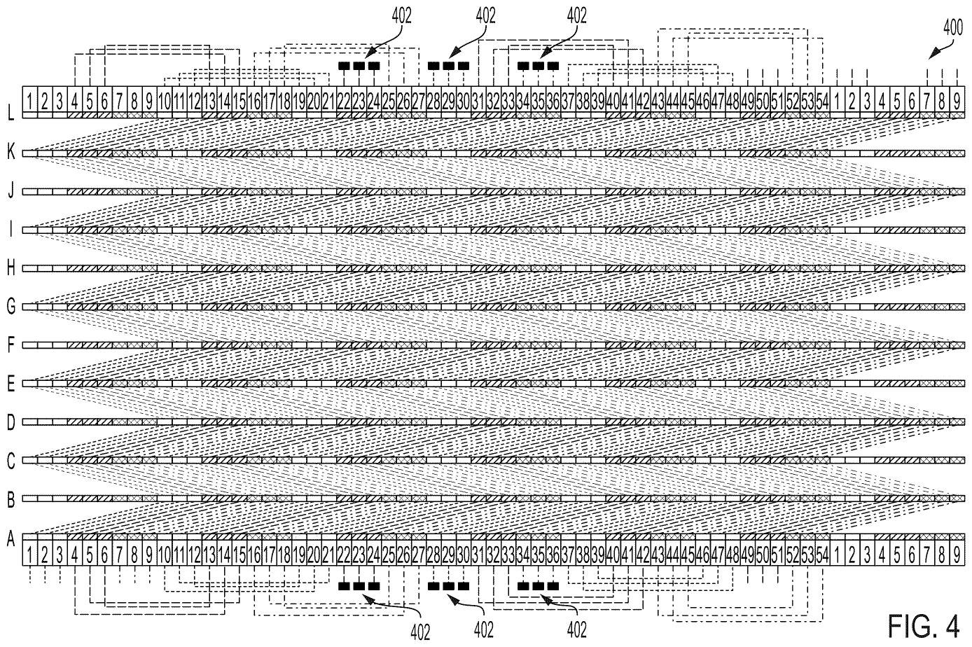

FIG. 4 shows a U, V, W terminal winding scheme 400 for a stator such as the stator 108 shown in FIG. 1 and/or the stator 200 shown in FIGS. 2A-2C. Again, rows A-L indicate the layers of the windings from an inner diameter at A to an outer diameter at L. Star point connections 402 in the both of the three-phase stator winding assemblies are shown in FIG. 4. However, in other examples, the winding assemblies may be connected in a delta configuration.

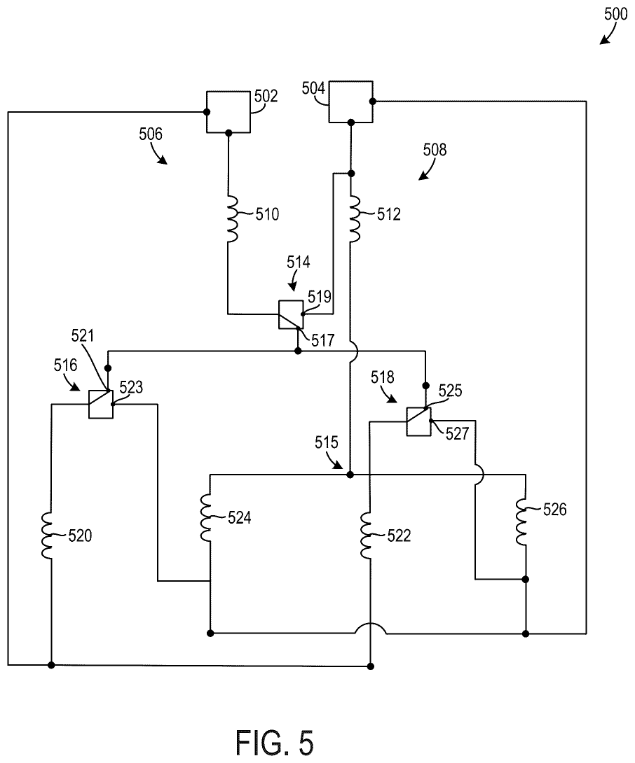

FIG. 5 shows another electric circuit diagram of an electric machine system 500 with winding reconfiguration functionality. In the diagram, circles represent electrical junctions. Again, the electric machine system may be included in an electric drive of a vehicle or a variety of other suitable operating environments.

The electric machine system 500 includes inverters 502 and 504. The inverter 502 is electrically coupled to three-phase winding assembly 506 and the inverter 504 is electrically coupled to three-phase winding assembly 508.

The three-phase winding assembly 506 includes phase winding 510 (e.g., a red phase winding). The three-phase winding assembly 508 includes phase winding 512 (e.g., a red phase winding). An electronic or mechanical switch 514 is further provided in the electric machine system 500. The switch 514 may specifically be a multi-position contactor. To elaborate, the switch 514 is a two-position contactor in the illustrated example. However, other switch configurations are possible. In a first position (indicated at 517) of the switch 514, the phase winding 510 is electrically coupled to the switches 516 and 518 that are discussed in greater detail herein.

In a second position (indicated at 519) of the switch 514, the phase winding 510 is electrically coupled in series with the phase winding 512 to electrically couple the phase windings 510 and 512 to a permanent star point connection 515.

The three-phase winding assembly 506 further includes phase windings 520 and 522. Further, the three-phase winding assembly 508 includes phase windings 524 and 526.

The switch 516 is a two position contactor in the illustrated example. When the electronic device 516 is in a first position (as indicated at 521), the phase winding 520 is electrically coupled to the switches 514 and 518. In a second position (indicated at 523) of the switch 516, the phase winding 520 is electrically coupled in series with the phase winding 524 to electrically couple the phase windings 520 and 524 to the permanent star point connection 515.

The switch 518 is a two position contactor in the illustrated example. When the electronic device 518 is in a first position (as indicated at 525), the phase winding 522 is electrically coupled to the switches 514 and 516.

In a second position (as indicated at 527) of the switch 518, the phase winding 522 is electrically coupled in series with the phase winding 526 to electrically couple the phase windings 522 and 526 to the permanent star point connection 515.

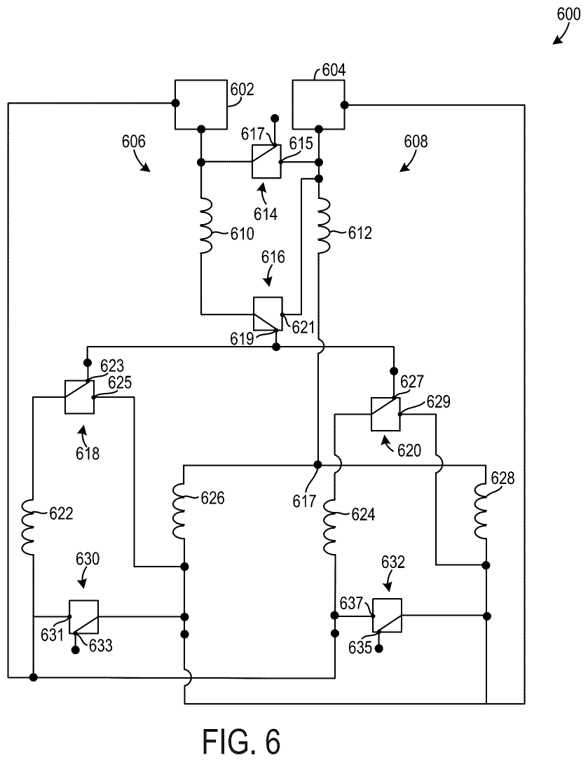

FIG. 6 shows another electric circuit diagram of an electric machine system 600 with winding reconfiguration functionality. In the diagram, circles represent electrical junctions. Again, the electric machine system 600 may be included in an electric drive of a vehicle or a variety of other operating environments.

The electric machine system 600 includes inverters 602 and 604. The inverter 602 is electrically coupled to one three-phase winding assembly 606 and the inverter 604 is electrically coupled to another three-phase winding assembly 608.

The three-phase winding assembly 606 includes phase winding 610 (e.g., a red phase winding). The three-phase winding assembly 608 includes phase winding 612 (e.g., a red phase winding).

A mechanical or electronic switch 614 is further provided in the electric machine system 600. The switch 614 may specifically be a multi-position contactor. In the illustrated example, the switch 614 electrically couples inputs of the phase windings 610 and 612 in a closed positioned (as indicated at 615). Conversely, in an open position (as indicated at 617) of the electronic device 614 the inputs of the phase windings 610 and 612 are electrically decoupled.

An electronic or mechanical switch 616 is further provided in the electric machine system 600 in the illustrated example. The switch 616 may specifically be an electronic switch such as a multi-position contactor. To elaborate, the switch 616 is a two-position contactor in the illustrated example. In a first position (as indicated at 619) of the switch 616, the phase winding 610 is electrically coupled to the electronic devices 618 and 620 that are discussed in greater detail herein. In a second position (as indicated at 621) of the switch 616, the phase winding 610 is electrically coupled in series with the phase winding 612 to electrically couple the phase windings 610 and 612 to a permanent star point connection 617.

The three-phase winding assembly 606 further includes a phase winding 622 and a phase winding 624. Similarly, the three-phase winding assembly 608 further includes a phase winding 626 and a phase winding 628.

An electronic or mechanical switch 618 is further provided in the electric machine system 600 in the illustrated example. The switch 618 may specifically be an electronic switch such as a multi-position contactor. To elaborate, the switch 618 is a two-position contactor in the illustrated example. In a first position (as indicated at 623) of the switch 618, the phase winding 622 is electrically coupled to the electronic devices 616 and 620 that are discussed in greater detail herein. In a second position (as indicated at 625) of the switch 618, the phase winding 622 is electrically coupled in series with the phase winding 616 to electrically couple the phase windings 622 and 626 to a permanent star point connection 617.

An electronic or mechanical switch 620 is further provided in the electric machine system 600 in the illustrated example. The switch 620 may specifically be an electronic switch such as a multi-position contactor. To elaborate, the switch 620 is a two-position contactor in the illustrated example. In a first position (as indicated at 627) of the switch 620, the phase winding 624 is electrically coupled to the electronic devices 616 and 618 that are discussed in greater detail herein. In a second position (as indicated at 629) of the switch 620, the phase winding 624 is electrically coupled in series with the phase winding 628 to electrically couple the phase windings 624 and 628 to a permanent star point connection 617.

An electronic or mechanical switch 630 is further provided in the electric machine system 600. The electronic device may specifically be an electronic switch such as a multi-position contactor. In the illustrated example, the switch 630 electrically couples inputs of the phase windings 622 and 626 in a closed positioned (as indicated at 631). Conversely, in an open position (as indicated at 633) of the switch 630 the inputs of the phase windings 622 and 626 are electrically decoupled.

An electronic or mechanical switch 632 is further provided in the electric machine system 600. The switch 632 may specifically be an electronic switch such as a multi-position contactor. In an open position (as indicated at 635) of the switch 632 the inputs of the phase windings 624 and 628 are electrically decoupled. Further, in the illustrated example, the switch 632 electrically couples inputs of the phase windings 624 and 628 in a closed positioned (as indicated at 637).

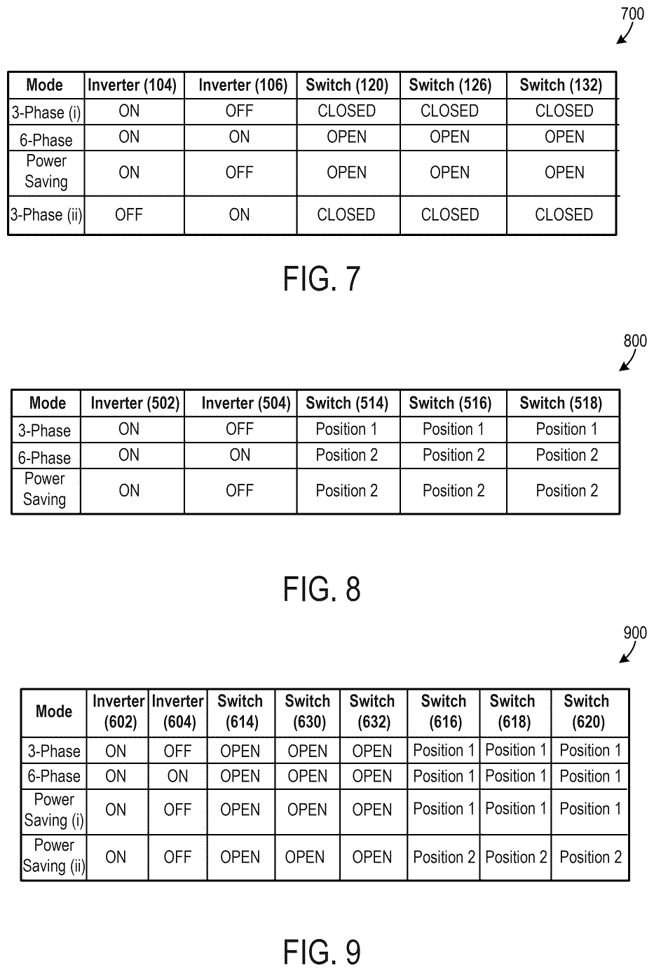

FIGS. 7-9 show operational charts for the different electric machine architectures shown in FIGS. 1, 5, and 6. It will be understood, that the different control steps in the modes and the transitions between the modes may be implemented as executable instructions stored in memory of a controller.

FIG. 7 shows an operational diagram 700 for the electric machine system 100 shown in FIG. 1. The operational states of the inverter 104, the inverter 106, the switch 120, the switch 126, and the switch 132 in a first three-phase mode, a second three-phase mode, a six-phase mode, and a power saving mode are depicted in FIG. 7.

In the first three-phase mode, the inverter 104 is turned on, the inverter 106 is turned off, the switch 120 is closed, the switch 126 is closed, and the switch 132 is closed. It will be understood, that in the three-phase mode, peak torque and continuous torque may be delivered if the inverter 104 is at least twice the size of the inverter 106.

In the second three-phase mode, the inverter 104 is turned off, the inverter 106 is turned on, the switch 120 is closed, the switch 126 is closed, and the switch 132 is closed. It will be understood, that in the three-phase mode, peak torque and continuous torque may be delivered if the inverter 104 is at least twice the size of the inverter 106.

In the six-phase mode, the inverter 104 is turned on, the inverter 106 is turned on, the switch 120 is open, the switch 126 is open, and the switch 132 is open.

In the power saving mode, the inverter 104 is turned on, the inverter 106 is turned off, the switch 120 is open, the switch 126 is open, and the switch 132 is open. Alternatively, in the power saving mode the inverter 104 may be turned off and the inverter 106 may be turned on. In the power saving mode, the power consumption of the drive unit is less than the three-phase mode or the six-phase mode.

FIG. 8 shows an operational diagram 800 for the electric machine system 500 shown in FIG. 5. The operational states of the inverter 502, the inverter 504, the switch 514, the switch 516, and the switch 518 in a three-phase mode, a six-phase mode, and a power saving mode are depicted in FIG. 8.

In the three-phase mode, the inverter 502 is turned on, the inverter 504 is turned off, the switch 514 is in the first position, the switch 516 is in the first position, and the switch 518 is in the first position. It will be understood, that in the three-phase mode, peak torque and continuous torque may be delivered but the base speed in the three-phase mode may be reduced by half, when compared to the six-phase mode.

In the six-phase mode, the inverter 502 is turned on, the inverter 504 is turned on, the switch 514 is in the second position, the switch 516 is in the second position, and the switch 518 is in the second position.

In the power saving mode, the inverter 502 is turned on, the inverter 504 is turned off, the switch 514 is in the second position, the switch 516 is in the second position, and the switch 518 is in the second position. In the power saving mode, the power consumption of the drive unit is less than the three-phase mode or the six-phase mode. It will be understood, that in the power saving mode, peak torque and continuous torque may be delivered but the base speed in the three-phase mode may be reduced by half, when compared to the six-phase mode.

In one example, the electric machine system 500 may be controlled to switch the inverter 504 on when the speed/torque that is generated by the electric machine while solely the inverter 502 is below a target set-point. Further, when the inverter 504 is turned on, the switches 514, 516, and 516 may be in their second positions thereby placing the stator circuitry in a star configuration. In this way, both inverters may be turned on when control set-points surpass the capacity of a single inverter, thereby increasing machine adaptability and performance, more generally.

FIG. 9 shows an operational diagram 900 for the electric machine system 600 shown in FIG. 6. The operational states of the inverter 602, the inverter 604, the switch 614, the switch 616, and the switch 618, the switch 620, the switch 630, and the switch 632 in a three-phase mode, a six-phase mode, and a power saving mode are depicted in FIG. 9.

In the three-phase mode, the inverter 602 is turned on, the inverter 604 is turned off, the switch 614 is open, the switch 630 is open, and the switch 632 is open, the switch 616 is the first position, the switch 618 is in the first position, and the switch 620 is in the first position. Specifically, the switches 616, 618, and 620 are in their first positions and connected in a star configuration. It will be understood, that in the three-phase mode, peak torque and continuous torque may be delivered by the system.

In the six-phase mode, the inverter 602 is turned on, the inverter 604 is turned on, the switch 614 is open, the switch 630 is open, and the switch 632 is open. Further, in the six-phase mode, the switch 616 is the first position, the switch 618 is in the first position, and the switch 620 is in the first position and these switches are connected in a star configuration.

In the power saving mode (i), the inverter 602 is turned on, the inverter 604 is turned off, the switch 614 is closed, the switch 630 is closed, and the switch 632 is closed, the switch 616 is open, the switch 618 is open, and the switch 620 is open. Specifically, the switches 616, 618, and 620 are open and connected in a star configuration. The power saving mode may be implemented at reduced power when one of the three-phase winding is non-operational.

In the power saving mode (ii), the inverter 602 is turned on, the inverter 604 is turned off, the switch 614 is open, the switch 630 is open, and the switch 632 is open, the switch 616 is the second position, the switch 618 is the second position, and the switch 620 is in the second position. In the power saving mode (ii), peak torque and continuous torque will be doubled for same current the system but the base speed in the three-phase mode may be reduced by half, when compared to the six-phase mode.

It will be understood, that the power saving modes described herein allow the system to achieve redundancy in power delivery to the stator thereby increasing system reliability in the power saving mode.

In any of the electric machine systems 100, 500, and 600 or combinations of the electric machine systems, the system may transition between the different modes based on the operating conditions in the powertrain, vehicle, etc. To elaborate, the systems may be switched from the three-phase mode to the six-phase mode when a speed or torque set-point surpasses a threshold value (e.g., a threshold value that corresponding to a maximum value that a single inverter can deliver) and vice versa. In another example, the system may be switched into the power saving mode from the three-phase mode when a speed or torque set-point drops below a threshold value. In this way, system efficiency or torque is increased.

The technical effect of the methods for operation of the electric machine system described herein is to quickly and efficiently switch between a three-phase mode and a six-phase mode during motoring, thereby increasing the machine's adaptability and performance.

FIGS. 2A-2C are drawn approximately to scale, aside from the schematically depicted components therein. However, at least a portion of the system components may have other relative dimensions, in other examples.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The invention will further be described in the following paragraphs. In one aspect, an electric machine system is provided that comprises a stator including: a first three-phase winding assembly electrically coupled in parallel to a second three-phase winding assembly; and a plurality of electronic and/or mechanical switches that are configured to selectively electrically couple the first and second three-phase winding assemblies; a first inverter electrically coupled to the first three-phase winding assembly; and a second inverter electrically coupled to the second three-phase winding assembly. In one example, the electric machine may further comprise a controller configured to: operate the electric machine system in a three-phase motoring mode during a first condition; and operate the electric machine system in a six-phase motoring mode during a second condition. In one example, the first three-phase winding assembly may be mechanically distributed from 0°-180° around a circumference of the stator in an even number of parallel paths; and the second three-phase winding assembly may be mechanically distributed from 180°-360° around the circumference of the stator in an even number of parallel paths. In one example, operating the electric machine system in the three-phase mode may include: operating one of the first and second inverters to transfer power to the first three-phase winding assembly or the second first three-phase winding assembly, respectively, while the other inverter is turned off; and closing the plurality of electronic and/or mechanical switches. In one example, operating the electric machine system in the six-phase mode may include: operating the first and second inverters to transfer power to the first three-phase winding assembly and the second first three-phase winding assembly, respectively; and opening the plurality of electronic and/or mechanical switches. Further, in one example, the plurality of electronic and/or mechanical contacts may be electronic switches. In one example, the plurality of electronic devices may include three contactors. In one example, the three contactors may be configured to selectively electrically couple different phases in each of the first three-phase winding assembly and the second three-phase winding assembly. In one example, the three contactors may be configured to selectively electrically couple phases in each of the first three-phase winding assembly and the second three-phase winding assembly to a permanent star point. In one example, the plurality of electronic devices may include six electronic devices; a first portion of the six electronic devices may be configured to selectively electrically couple different phases in each of the first three-phase winding assembly and the second three-phase winding assembly; and a second portion of the six electronic devices may be configured to selectively electrically couple phases in each of the first three-phase winding assembly and the second three-phase winding assembly to a permanent star point. In one example, the first three-phase winding assembly and the second three-phase winding assembly may each include a plurality of hairpin windings; and the first three-phase winding assembly and the second three-phase winding assembly may be each arranged in a star configuration. In one example, an electrical winding phase may shift between the three-phase mode and the six-phase mode is 0°. In one example, the first three-phase winding assembly and the second three-phase winding assembly may be hairpin winding assemblies.

In one aspect, a method for operation of an electric machine system is provided that comprises operating the electric machine system in a three-phase motoring mode; and operating the electric machine system in a six-phase motoring mode; wherein the electric machine includes: a stator including: a first three-phase winding assembly electrically coupled in parallel to a second three-phase winding assembly electrically coupled in parallel to the first three-phase assembly; a first inverter electrically coupled to the first three-phase winding assembly; a second inverter electrically coupled to the second three-phase winding assembly; and a plurality of electronic devices that are configured to selectively electrically couple the first and second three-phase winding assemblies. In one example, operating the electric machine system in the three-phase mode may include operating one of the first and second inverters to transfer power to the first three-phase winding assembly or the second first three-phase winding assembly, respectively, while the other inverter is turned off and closing the plurality of electronic device; and operating the electric machine system in the six-phase mode includes operating the first and second inverters to transfer power to the first three-phase winding assembly and the second first three-phase winding assembly, respectively and opening the plurality of electronic devices.

In another aspect, an electric motor system is provided that comprises a stator including: a first three-phase hairpin winding assembly electrically coupled in parallel to a second three-phase hairpin winding assembly electrically coupled in parallel to the first three-phase hairpin winding assembly; a first inverter electrically coupled to the first three-phase hairpin winding assembly; a second inverter electrically coupled to the second three-phase hairpin winding assembly; a first set of three electronic switches that are configured to selectively electrically couple the first and second three-phase hairpin winding assemblies; and a controller configured to: operate the electric machine system in a three-phase motoring mode; and operate the electric machine system in a six-phase motoring mode; wherein an electrical winding phase shift between the three-phase mode and the six-phase mode is 0°. In one example, the stator may further comprise: a second set of three electronic switches that are configured to selectively electrically couple the first and second three-phase hairpin winding assemblies. In one example, the first set of three electronic switches may be configured to selectively electrically couple different phases in each of the first three-phase hairpin winding assembly and the second three-phase hairpin winding assembly. In one example, the second set of three electronic switches may be configured to selectively electrically couple phases in each of the first three-phase hairpin winding assembly and the second three-phase hairpin winding assembly to a permanent star point. Further in one example, the first three-phase hairpin winding assembly may be mechanically distributed from 0°-180° around a circumference of the stator in an even number of parallel paths; and the second three-phase hairpin winding assembly may be mechanically distributed from 180°-360° around the circumference of the stator in an even number of parallel paths.

In another representation, a traction motor is provided that comprises multiple main three-phase winding circuits that are electrically connected to one another in parallel. The traction motor further comprises multiple power electronic devices that are electrically connected to the three-phase winding circuits. Multiple contactors are further included in the traction motor and designed to switch the traction motor between a three-phase motoring mode and a six-phase motoring mode.

Note that the example control and estimation routines included herein can be used with various electric machine and/or vehicle configurations. The control methods and routines disclosed herein may be stored as executable instructions in non-transitory memory and may be carried out by the control system including the controller in combination with the various sensors, actuators, and other electric machine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the electric machine control system, where the described actions are carried out by executing the instructions in a system including the various electric machine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to various types of electric motors and vehicle configurations. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine system, comprising:
a stator including:
a first three-phase winding assembly electrically coupled in parallel to a second three-phase winding assembly; and
a plurality of electronic and/or mechanical switches that are configured to selectively electrically couple the first and second three-phase winding assemblies;
a first inverter electrically coupled to the first three-phase winding assembly; and
a second inverter electrically coupled to the second three-phase winding assembly.

2. The electric machine system of claim 1, further comprising:
a controller configured to:
operate the electric machine system in a three-phase motoring mode during a first condition; and
operate the electric machine system in a six-phase motoring mode during a second condition.

3. The electric machine system of claim 1, wherein:
the first three-phase winding assembly is mechanically distributed from 0°-180° around a circumference of the stator in an even number of parallel paths; and
the second three-phase winding assembly is mechanically distributed from 180°-360° around the circumference of the stator in an even number of parallel paths.

4. The electric machine system of claim 3, wherein operating the electric machine system in the three-phase mode includes:
operating one of the first and second inverters to transfer power to the first three-phase winding assembly or the second first three-phase winding assembly, respectively, while the other inverter is turned off; and
closing the plurality of electronic and/or mechanical switches.

5. The electric machine system of claim 3, wherein operating the electric machine system in the six-phase mode includes:
operating the first and second inverters to transfer power to the first three-phase winding assembly and the second first three-phase winding assembly, respectively; and
opening the plurality of electronic and/or mechanical switches.

6. The electric machine system of claim 1, wherein the plurality of electronic and/or mechanical contacts are electronic switches.

7. The electric machine system of claim 1, wherein the plurality of electronic devices include three contactors.

8. The electric machine system of claim 7, wherein the three contactors are configured to selectively electrically couple different phases in each of the first three-phase winding assembly and the second three-phase winding assembly.

9. The electric machine system of claim 7, wherein the three contactors are configured to selectively electrically couple phases in each of the first three-phase winding assembly and the second three-phase winding assembly to a permanent star point.

10. The electric machine system of claim 1, wherein:
the plurality of electronic devices include six electronic devices;
a first portion of the six electronic devices are configured to selectively electrically couple different phases in each of the first three-phase winding assembly and the second three-phase winding assembly; and
a second portion of the six electronic devices are configured to selectively electrically couple phases in each of the first three-phase winding assembly and the second three-phase winding assembly to a permanent star point.

11. The electric machine system of claim 1, wherein:
the first three-phase winding assembly and the second three-phase winding assembly each include a plurality of hairpin windings; and
the first three-phase winding assembly and the second three-phase winding assembly are each arranged in a star configuration.

12. The electric machine system of claim 1, wherein an electrical winding phase shift between the three-phase mode and the six-phase mode is 0°.

13. The electric machine system of claim 1, wherein the first three-phase winding assembly and the second three-phase winding assembly are hairpin winding assemblies.

14. A method for operation of an electric machine system, comprising:
operating the electric machine system in a three-phase motoring mode; and
operating the electric machine system in a six-phase motoring mode;
wherein the electric machine includes:
a stator including:
a first three-phase winding assembly electrically coupled in parallel to a second three-phase winding assembly electrically coupled in parallel to the first three-phase assembly;
a first inverter electrically coupled to the first three-phase winding assembly;
a second inverter electrically coupled to the second three-phase winding assembly; and
a plurality of electronic devices that are configured to selectively electrically couple the first and second three-phase winding assemblies.

15. The method of claim 14, wherein:
operating the electric machine system in the three-phase mode includes operating one of the first and second inverters to transfer power to the first three-phase winding assembly or the second first three-phase winding assembly, respectively, while the other inverter is turned off and closing the plurality of electronic device; and
operating the electric machine system in the six-phase mode includes operating the first and second inverters to transfer power to the first three-phase winding assembly and the second first three-phase winding assembly, respectively and opening the plurality of electronic devices.

16. An electric motor system, comprising:
a stator including:
a first three-phase hairpin winding assembly electrically coupled in parallel to a second three-phase hairpin winding assembly electrically coupled in parallel to the first three-phase hairpin winding assembly;
a first inverter electrically coupled to the first three-phase hairpin winding assembly;
a second inverter electrically coupled to the second three-phase hairpin winding assembly;
a first set of three electronic switches that are configured to selectively electrically couple the first and second three-phase hairpin winding assemblies; and
a controller configured to:
operate the electric machine system in a three-phase motoring mode; and
operate the electric machine system in a six-phase motoring mode;
wherein an electrical winding phase shift between the three-phase mode and the six-phase mode is 0°.

17. The electric motor system of claim 16, wherein the stator further comprises:
a second set of three electronic switches that are configured to selectively electrically couple the first and second three-phase hairpin winding assemblies.

18. The electric motor system of claim 17, wherein the first set of three electronic switches are configured to selectively electrically couple different phases in each of the first three-phase hairpin winding assembly and the second three-phase hairpin winding assembly.

19. The electric motor system of claim 17, wherein the second set of three electronic switches are configured to selectively electrically couple phases in each of the first three-phase hairpin winding assembly and the second three-phase hairpin winding assembly to a permanent star point.

20. The electric motor system of claim 16, wherein:
the first three-phase hairpin winding assembly is mechanically distributed from 0°-180° around a circumference of the stator in an even number of parallel paths; and
the second three-phase hairpin winding assembly is mechanically distributed from 180°-360° around the circumference of the stator in an even number of parallel paths.
